(19) United States
(12) Patent Application Publication
(10) Pub. No.: US 2010/0315325 A1
(43) Pub. Date: Dec. 16, 2010

(54) LIGHT SOURCE UNIT AND DISPLAY APPARATUS INCLUDING THE SAME

(75) Inventor: Young-Soo HWANG, Goyang-si (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/816,865

(22) Filed: Jun. 16, 2010

(30) Foreign Application Priority Data
Jun. 16, 2009 (KR) 10-2009-0053523
Mar. 9, 2010 (KR) 10-2010-0020796

(51) Int. Cl. G09G 3/36; H05B 37/02

(52) U.S. Cl. 345/102; 315/291; 315/127

(57) ABSTRACT

A light source unit includes a light source which generates light and a light source driver which drives the light source and includes a driving integrated circuit and a resistance device. The driving integrated circuit includes an input terminal which receives an input voltage from an external source, converts the input voltage into a driving voltage which drives the light source. The resistance device is connected between an input terminal of the driving integrated circuit and a ground terminal and supplies the input voltage to the ground terminal by changing a resistance value thereof according to the input voltage when a level of the input voltage exceeds a preset level.

This application claims priorities to Korean Patent Application No. 2009-53523, filed on Jun. 16, 2009, and Korean Patent Application No. 2010-20796, filed on Mar. 9, 2010, and all the benefits accruing therefrom under 35 U.S.C. §119, the content of which in their entirety is herein incorporated by reference.

### BACKGROUND OF THE INVENTION

1. Field of the Invention

The present invention relates to a light source unit and a display apparatus including the light source unit and, more particularly, to a light source unit in which damage caused by an over-voltage is effectively prevented, and a display apparatus including the light source unit.

2. Description of the Related Art

A liquid crystal display (“LCD”) typically includes two substrates and a liquid crystal layer interposed therebetween. The liquid crystal display applies an electric field to the liquid crystal layer to control transmittance of light passing through the liquid crystal layer by adjusting an intensity of the electric filed, thereby displaying a desired image. However, since the liquid crystal display is not a self-emission display, the liquid crystal display requires an additional light source unit, such as a backlight unit.

The backlight unit typically includes a backlight including fluorescent lamps or, alternatively, light emitting diodes, and a backlight driver to drive the backlight. The backlight driver receives a voltage from an external source and supplies a driving voltage to the backlight using the voltage received from the external source. However, when the backlight driver receives an over-voltage from the external source, the backlight driver operates incorrectly and/or is damaged.

### BRIEF SUMMARY OF THE INVENTION

Exemplary embodiments of the present invention provide a light source unit having advantages that include, but are not limited to, effectively preventing erroneous operation and/or damage caused by an over-voltage supplied to a backlight driver of the light source unit.

Exemplary embodiments of the present invention also provide a display apparatus including the light source unit, and a method of driving the same.

According to exemplary embodiments of the present invention, a light source unit includes a light source which generates light and a light source driver which drives the light source and includes a driving integrated circuit and a resistance device. The driving integrated circuit includes an input terminal which receives an input voltage from an external source and converts the input voltage into a driving voltage which drives the light source. The resistance device is connected between the input terminal of the driving integrated circuit and a ground terminal and has a resistance value changed according to a level of the input voltage.

The light source unit further includes a fuse which receives the input voltage from the external source and supplies the input voltage to the input terminal of the driving integrated circuit. The fuse is opened when the level of the input voltage is greater than a preset level.

The resistance device may include a varistor, and the resistance device let the input voltage go through to the ground terminal by decreasing the resistance value of itself when the level of the input voltage is greater than the preset level before the fuse get opened.

According to another alternative exemplary embodiment of the present invention, a display apparatus includes a display panel which displays an image, a light source which supplies light to the display panel and a light source driver which drives the light source and includes a driving integrated circuit and a resistance device. The driving integrated circuit includes an input terminal which receives an input voltage from an external source, converts the input voltage into a driving voltage which drives the light source. The resistance device is connected between the input terminal of the driving integrated circuit and a ground terminal and transmit the input voltage to the ground terminal by changing a resistance value of the resistance device according to a level of the input voltage.

In yet another alternative exemplary embodiment, in a method of driving a light source including a light source driver having a driving integrated circuit and a resistance device, the method includes: receiving an input voltage from an external source with the driving integrated circuit; converting the input voltage into a driving voltage and outputting the driving voltage to the light source with the driving integrated circuit; and supplying the input voltage to a ground terminal by changing a resistance value of the resistance device corresponding to the input voltage when a level of the input voltage exceeds a preset level.

Thus, according to exemplary embodiments as described herein, a resistance device is connected to an input terminal of a driving integrated circuit, and an over-voltage inputted thereto from an external source is by-passed by the resistance device. Therefore, a driving device according to an exemplary embodiment of the present invention is prevented from being damaged due to the over-voltage.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a display apparatus according to the present invention;

FIG. 2 is a schematic circuit diagram of a light source unit of the display apparatus of FIG. 1;

FIG. 3 is a block diagram of a driving integrated circuit of the light source unit of FIG. 2;

FIG. 4 is a schematic circuit diagram of another exemplary embodiment of a resistance device of the light source unit of FIG. 2; and

FIG. 5 is a schematic circuit diagram of another exemplary embodiment of a light source unit.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

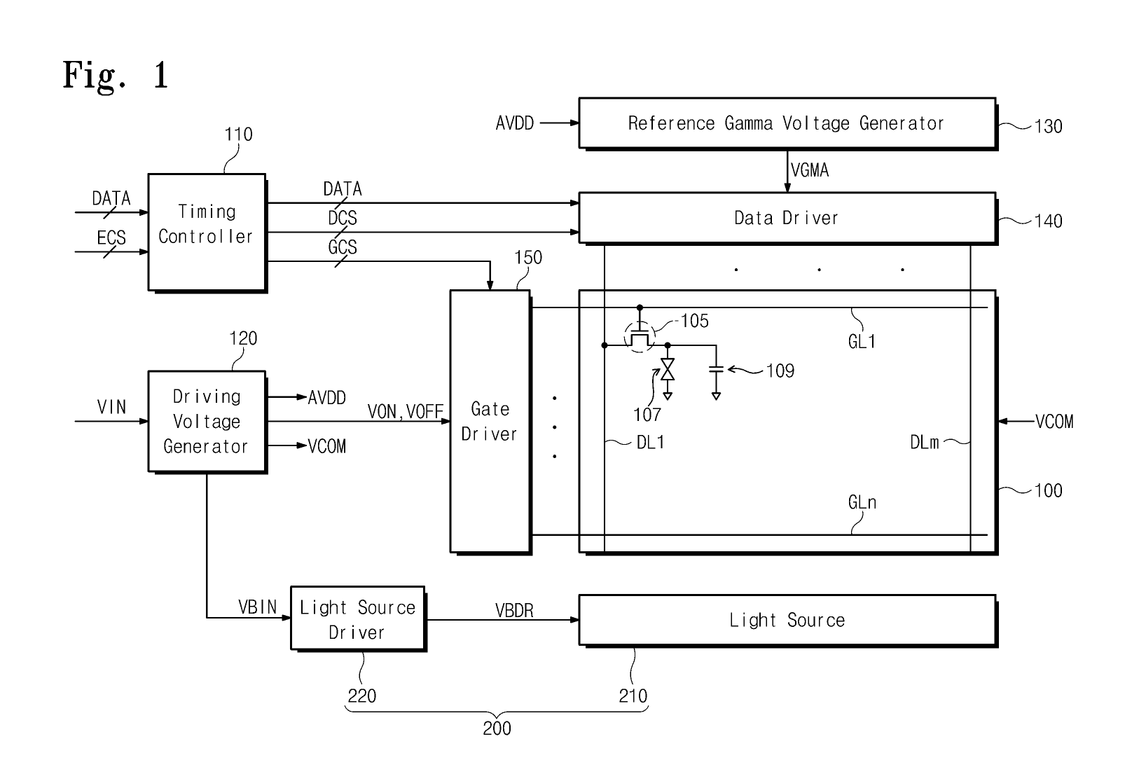

FIG. 1 is a block diagram of an exemplary embodiment of a display apparatus according to the present invention.

Referring to FIG. 1, the display apparatus includes a display panel 100, a timing controller 110, a driving voltage generator 120, a reference gamma voltage generator 130, a data driver 140, a gate driver 150 and a light source unit 200.

The display panel 100 includes upper and lower substrates (not shown) facing each other with liquid crystal (not shown) interposed therebetween. More specifically, the display panel 100 includes gate lines GL1 to GLn extending along a first direction and spaced apart from each other along a second direction, substantially perpendicular to the first direction, data lines DL1 to DLm extending along the second direction substantially perpendicular to the gate lines GL1 to GLn. The display panel 100 further includes thin film transistors 105, a liquid crystal capacitor 107 and a storage capacitor 109. Each of the transistors 105 includes a gate electrode connected to a corresponding gate line of the gate lines GL1 to GLn, a source electrode connected to a corresponding data line of the data lines DL1 to DLm, and a drain electrode connected in parallel with the liquid crystal capacitors 107 and the storage capacitors 109.

The timing controller 110 receives a data signal DATA and an external control signal ECS from an external source (not shown). The timing controller 110 generates a data control signal DCS and a gate control signal GCS based on the external control signal ECS. The timing controller 110 supplies the data control signal DCS and the gate control signal GCS to the data driver 140 and the gate driver 150, respectively. The timing controller 110 supplies the data signal DATA to the data driver 140.

The driving voltage generator 120 receives an input voltage VIN from an external source (not shown) and generates driving voltages, which are used to drive the display panel 100, the reference gamma voltage generator 130, the gate driver 150 and the light source unit 200, and supplies the generated driving voltages to the display panel 100, the reference gamma voltage generator 130, the gate driver 150 and the light source unit 200. In an exemplary embodiment, for example, the driving voltage generator 120 supplies a common voltage VCOM to the display panel 100, and supplies an analog driving voltage AVDD to the reference gamma voltage generator 130. The driving voltage generator 120 supplies a gate on voltage VON and a gate off voltage VOFF to the gate driver 150, and supplies a light source input voltage VBIN to the light source unit 200.

The reference gamma voltage generator 130 generates reference gamma voltages VGMA using the analog driving voltage AVDD, and supplies the reference gamma voltages VGMA to the data driver 140.

The data driver 140 converts the data signal DATA, received from the timing controller 110, into an analog data voltage using the data control signal DCS and the reference gamma voltages VGMA, and supplies the analog data voltage to the display panel 100.

The gate driver 150 generates gate signals using the gate control signal GCS, the gate on voltage VON and the gate off voltage VOFF, and sequentially supplies the gate signals to the gate lines GL1 to GLn.

The light source unit 200 includes a light source 210 which supplies light to the display panel 100, and a light source driver 220 which drives the light source 210.

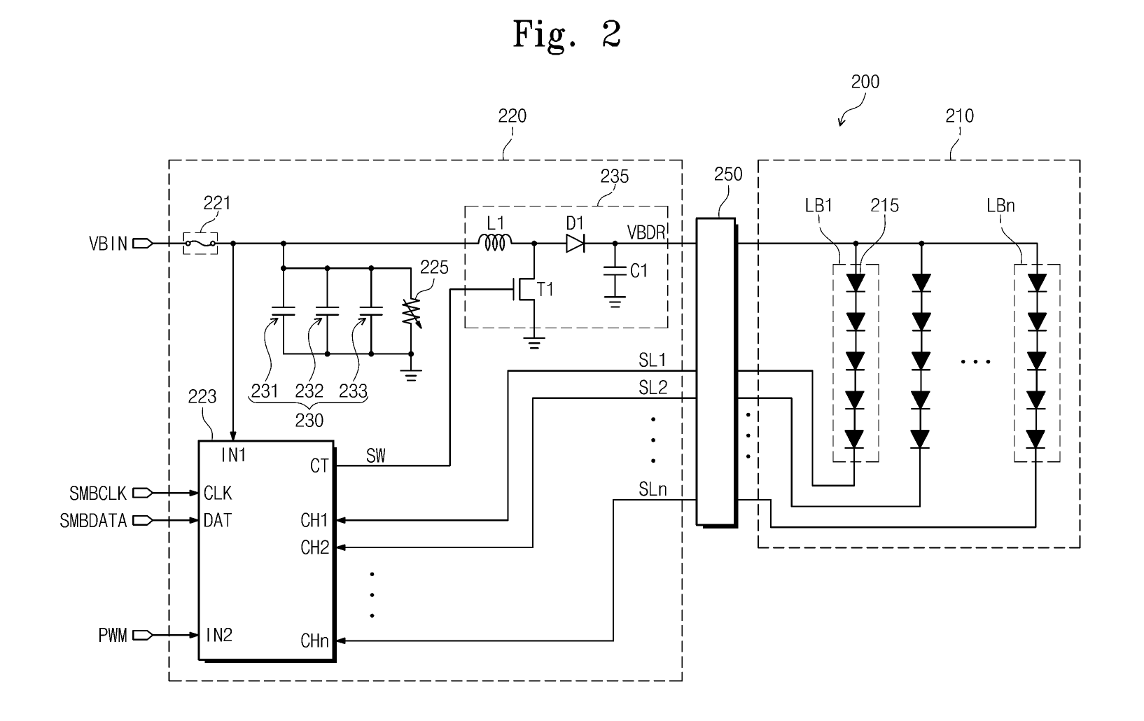

In an exemplary embodiment of the present invention, the light source 210 includes light emitting diodes (“LEDs”) 215, as will be described in greater detail below with reference to FIG. 2. The light source unit 200 may be classified as either a direct illumination type or an edge illumination type backlight according to a position of the light source 210. In the direct illumination type light source unit 200, the light source 210 may be disposed at a rear portion, e.g., a portion opposite a front portion on which the image is displayed, of the display panel 100 to supply light to the display panel 100. In contrast, a edge illumination type light source unit 200 may include the light source 210 disposed at a side portion of the display panel 100 to supply light to the display panel 100 and may include a light guide plate (not shown) provided at the rear portion of the display panel 100 to direct the light towards the front portion on which the image is displayed.

The light source driver 220 converts the light source input voltage VBIN from the driving voltage generator 120 into a light source driving voltage VBDR, which drives the light source 210, and supplies the light source driving voltage VBDR to the light source 210. The light source driver 220 will be described in further detail below with reference to FIG. 2.

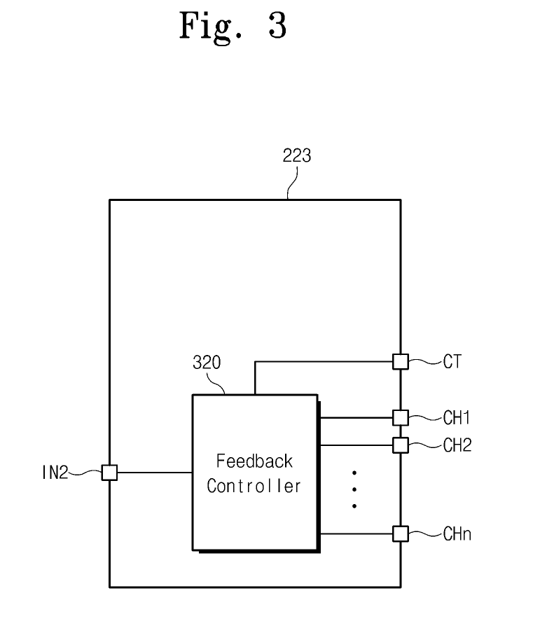

FIG. 2 is a schematic circuit diagram of an exemplary embodiment of the light source unit 200 of the display apparatus shown in FIG. 1, and FIG. 3 is a block diagram of an exemplary embodiment of a driving integrated circuit 223 of the light source unit 200 shown in FIG. 2.

Referring to FIGS. 2 and 3, the light source unit 200 includes the light source 210 which generates the light, the light source driver 220 which supplies the driving voltage to the light source 210 and a connector 250 which connects the light source 210 and the light source driver 220.

The light source 210 includes light emitting blocks LB1 to LBn connected in parallel with each other, and each of the light emitting blocks LB1 to LBn includes the light emitting diodes 215, which are connected to each other in series, as shown in FIG. 2. The light source 210 is connected to the light source driver 220 through the connector 250.

The light source driver 220 includes a direct-current-to-direct-current (DC-DC) converter 235 boosting the light source input voltage VBIN supplied from the external source to the light source driving voltage VBDR and a driving integrated circuit 223 controlling an operation of the light emitting blocks LB1 to LBn.

The DC-DC converter 235 includes a coil L1 boosting the light source voltage VBIN to the light source driving voltage VBDR, a diode D1 used to maintain the light source driving voltage VBDR at a constant level, a capacitor C1 stabilizing the light source driving voltage VBDR, and a switching device T1 connected to a control terminal CT of the driving integrated circuit 223 to receive a switching signal SW.

The switching device T1 is turned on or turned off in response to the switching signal SW, and the coil L1 boosts the light source input voltage VBIN according to an on/off operation of the switching device T1. Therefore, a level of the light source driving voltage VBDR, which is outputted from the DC-DC converter 235, may be varied according to a duty ratio of the switching device SW. More specifically, the level of the light source driving voltage VBDR decreases when the duty ratio of the switching signal SW decreases. On the contrary, when the duty ratio of the switching signal SW increases, the level of the light source driving voltage VBDR increases.

The light source driving voltage VBDR output from the DC-DC converter 235 is supplied to input terminals of the light emitting blocks LB1 to LBn.

On the other hand, the driving integrated circuit 223 controls the duty ratio of the switching signal SW based on current values feedback from the light emitting blocks LB1 to LBn through channels CH1 to CHn, which are connected to output terminals of the light emitting blocks LB1 to LBn. According to FIG. 2, the switching device T1 is disposed outside the driving integrated circuit 223, but the switching device T1 may be disposed inside the driving integrated circuit 223.

The driving integrated circuit 223 receives the light source input voltage VBIN via a first input terminal IN1 and receives a pulse width modulation signal PWM via a second input terminal IN2. The driving integrated circuit 223 receives data SMBDATA and clocks SMBCLK using a System Management BUS (SMBUS) method. The data SMBDATA may include brightness control information, error detection information, dimming control information, etc., but not limited thereto.

The connector 250 receives the light source driving voltage VBDR from the DC-DC converter 235 and supplies the light source driving voltage VBDR to the input terminals of the light emitting blocks LB1 to LBn. The connector 250 is connected to the output terminals of the light emitting blocks LB1 to LBn and supplies the current value, which is feedback from the light emitting blocks LB1 to LBn, to the driving integrated circuit 223.

As shown in FIG. 3, the driving integrated circuit 223 includes a feedback controller 320.

The feedback controller 320 receives the current value feedback from the light emitting blocks LB1 to LBn via the channels CH1 to CHn and receives the pulse width modulation signal PWM via the second input terminal IN2. Accordingly, the feedback controller 320 controls a duty ratio of the pulse width modulation signal PWM according to the feedback current values and outputs the controlled pulse width modulation signal PWM through the control terminal CT as the switching signal SW. More specifically, the feedback controller 320 decreases the duty ratio of the pulse width modulation signal PWM when the feedback current values are greater than a predetermined reference value, and increases the duty ratio of the pulse width modulation signal PWM when the feedback current values are smaller than the reference value. Also, the feedback controller 320 supplies the pulse width modulation signal PWM having a varied duty ratio to the DC-DC converter 235 as the switching signal SW.

In an exemplary embodiment, the light source driver 220 further includes a fuse 221 connected to the first input terminal IN1 of the driving integrated circuit 223. The fuse 221 is opened when the light source input voltage VBIN is an over voltage, e.g., when a level of the light source input voltage VBIN is greater than a predetermined reference level and blocks a flow of the over-voltage through the driving integrated circuit 223 and the DC-DC converter 235.

The light source driver 220 further includes a voltage stabilizing capacitance 230 and a resistance device 225.

The voltage stabilizing capacitance 230 includes at least one capacitor 231, 232, 233 connected in parallel with the fuse and the DC-DC converter 235 to stabilize the level of the light source input voltage VBIN. In an exemplary embodiment, the voltage stabilizing capacitance 230 may include a first capacitor 231, a second capacitor 232, and a third capacitor 233, which are connected in parallel with the resistance device 225.

The resistance device 225 is connected in parallel with the voltage stabilizing capacitance 230. More particularly, a first end of the resistance device 225 is connected to the first input terminal IN1 of the driving integrated circuit 223, and a second end, opposite the first end, of the resistance device 225 is connected to a ground terminal, as shown in FIG. 2. The resistance device 225 includes a variable resistor (“varistor”), the resistance value of which is varied when the light source input voltage VBIN exceeds a predetermined level. In an exemplary embodiment, a resistance value of the resistance device 225 may decrease as the level of the light source input voltage VBIN increases. Accordingly, when the light source input voltage VBIN is an over-voltage, which has a level greater than the predetermined level, a resistance value of the resistance device 225 decreases. As a result, current, which rapidly increases due to the over-voltage, is supplied to the ground terminal through the resistance device 225. Specifically, the resistance device 225 conducts the increased current to the ground terminal during a time required to get the fuse 221 opened. As a result, the driving integrated circuit 223 and the DC-DC converter 235 are protected effectively from being damaged by the increased current.

The light source driver 220 further includes signal lines SL1 to SLn to electrically connect the connector 250 and the channels CH1 to CHn of the driving integrated circuit 223. In some cases, each of the signal lines SL1 to SLn may be shorted with neighboring signal lines, due to environmental factors, for example. In this case, the resistance device 225 conducts an over-current, which is generated from shorted the signal lines SL1 to SLn, to the ground terminal, similar to as described above when the over-voltage is supplied from the external source (not shown).

When a voltage inputted from an external source (not shown) is an abnormal voltage or an over-voltage caused by discharge of static electricity, for example, the light source unit 200 cuts off an introduction of the over-voltage by opening the fuse 221, as discussed above. In addition, the over-voltage passing through the fuse 221 during the time which is required to get the fuse 221 opened is supplied to the ground terminal via the resistance device 225. Accordingly, the light source unit 200 according to an exemplary embodiment of this invention can effectively protects circuit elements (for example, the driving integrated circuit 223 and the DC-DC converter 235) thereof from being damaged by the abnormal voltage or the over-voltage.

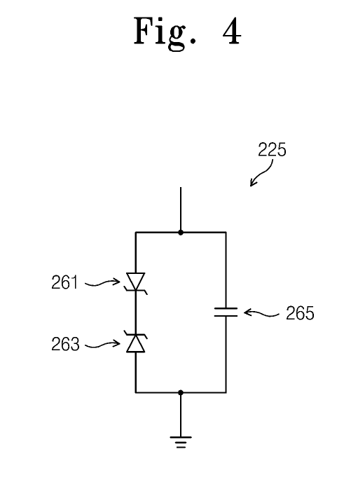

FIG. 4 is a schematic circuit diagram of an alternative exemplary embodiment of the resistance device 225 of the light source unit 200 shown in FIG. 2.

Referring to FIG. 4, the resistance device 225 according to an alternative exemplary embodiment includes a second diode 261 and a third diode 263, connected to each other in series and in opposite bias directions with respect to each other between the fuse 221 (FIG. 2) and the ground terminal, and a fourth capacitor 265 connected in parallel to both the second diode 261 and the third diode 263 between the fuse 221 (FIG. 2) and the ground terminal. In an exemplary embodiment, the second diode 261 and the third diode 263 may be zener diodes, but alternative exemplary embodiments are not limited thereto.

Thus, in the resistance device 225, when an over-voltage is applied, a reversed diode (of either the second diode 261 or the third diode 263) is turned on to supply the over-voltage to the ground terminal. Accordingly, in the resistance device 225, when an input voltage increase, a current rapidly increases, and a voltage supplied from the fuse 221 is conducted to the ground terminal. Further, in the resistance device 225, when the over-voltage is not applied, the resistance device 225 acts as a capacitor (e.g., the fourth capacitor 265), since the second diode 261 and the third diode 263 act as a high-resistance device. Accordingly, ripples are further prevented from occurring in the light source input voltage VBIN.

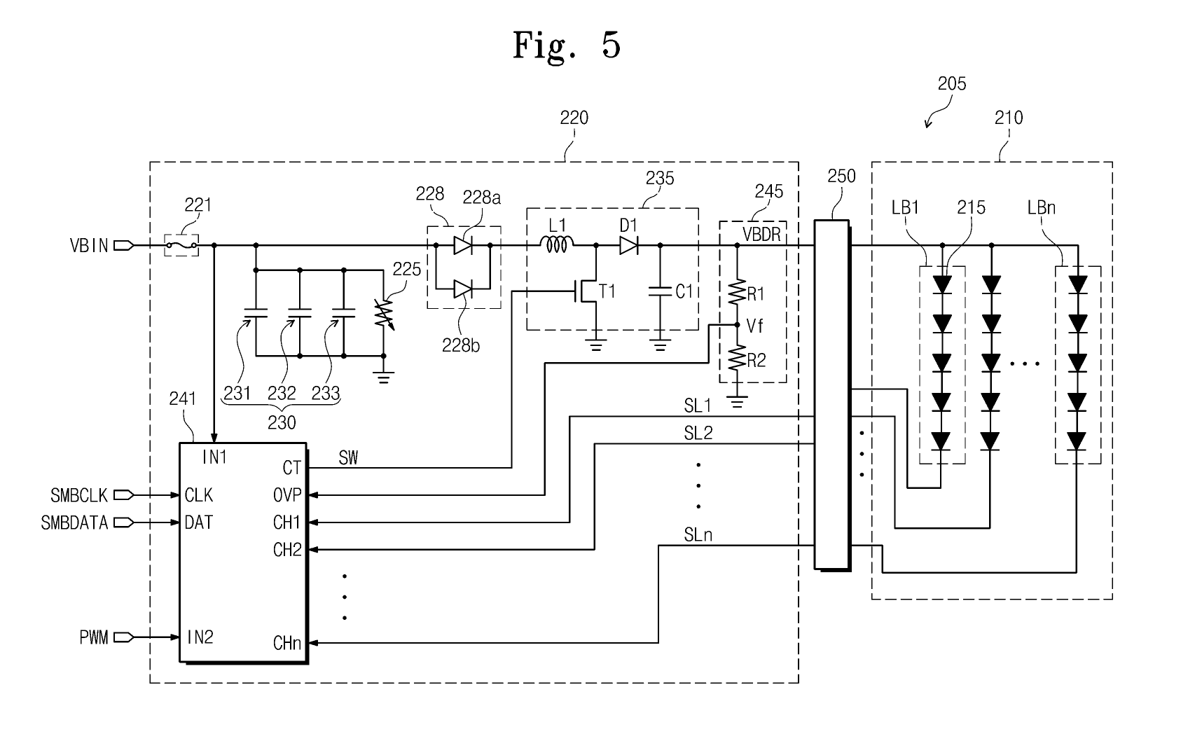

FIG. 5 is a schematic circuit diagram of another exemplary embodiment of a light source unit. In FIG. 5, the same reference numerals denote the same or like elements as shown in FIG. 2, and any detailed repetitive description thereof will hereinafter be omitted.

Referring to FIG. 5, in a light source unit 205 according to another exemplary embodiment, a light source driver, which drives the light source 210, further includes a reverse current blocking circuit 228.

The reverse current blocking circuit 228 includes at least one reverse current blocking diode 228a and 228b, which are arranged between the fuse 221 and the DC-DC converter 235. The reverse current blocking diode 228a and 228b rectifies the light source input voltage VBIN passing through the fuse 221 and prevents a reverse current from flowing through the fuse 221 or the driving integrated circuit 223.

The light source driver 240 further includes a voltage feedback part 245 connected to the output terminal of the DC-DC converter 235 to receive the light source driving voltage VBDR. The voltage feedback part 245 has a first resistance R1 and a second resistance R2, which are connected to the output terminal of the DC-DC converter 235 in series. The first and second resistances R1 and R2 are connected to each other in series between the output terminal of the DC-DC converter 235 and the ground terminal, and an electric potential Vf of a connection node connecting the first and second resistances R1 and R2 to each other is applied to a voltage feedback terminal OVP of the driving integrated circuit 223.

The driving integrated circuit 223 performs a protection operation when the electric potential Vf of the connection node, which is received through the voltage feedback terminal OVP, is greater than a predetermined reference electric potential. In addition, the driving integrated circuit 223 may control the DC-DC converter 235 according to the electric potential Vf of the connection node to adjust a level of the light source driving voltage VBDR output from the DC-DC converter 235.

The present invention should not be construed as being limited to the exemplary embodiments set forth herein. Rather, these exemplary embodiments are provided so that this disclosure will be thorough and complete and will fully convey the concept of the present invention to those skilled in the art.

For example, in yet another alternative exemplary embodiment, in a method of driving a light source (the light source including a light source driver having a driving integrated circuit and a resistance device), the method includes: receiving an input voltage from an external source with the driving integrated circuit; converting the input voltage into a driving voltage and outputting the driving voltage to the light source with the driving integrated circuit; and conducting the input voltage to a ground terminal by changing a resistance value of the resistance device when a level of the input voltage exceeds a preset level.

The method may further include: receiving feedback information about the driving voltage supplied to the light source with the driving integrated circuit; comparing the feedback information about the driving voltage with a reference level; and adjusting a level of the driving voltage and outputting the driving voltage having the adjusted level to the light source.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A light source unit comprising:
a light source which generates light; and
a light source driver which drives the light source,
wherein the light source driver comprises:
a driving integrated circuit comprising an input terminal which receives an input voltage from an external source, the driving integrated circuit converting the input voltage into a driving voltage which drives the light source; and
a resistance device connected between the input terminal of the driving integrated circuit and a ground terminal, the resistance device having a resistance value varied according to a level of the input voltage.

2. The light source unit of claim 1, wherein the light source driver further comprises a fuse which receives the input voltage from the external source and supplies the input voltage to the input terminal of the driving integrated circuit, and
the fuse is opened when the level of the input voltage is greater than a preset level.

3. The light source unit of claim 1, wherein the resistance device comprises a varistor, and
the resistance device provides the input voltage to the ground terminal when the fuse opens by decreasing the resistance value when the level of the input voltage is greater than the preset level.

4. The light source unit of claim 3, wherein the light source driver further comprises:
at least one capacitor connected in parallel with the resistance device.

5. The light source unit of claim 2, wherein the light source driver further comprises a direct-current-to-direct-current converter converting the input voltage passing through the fuse into the driving voltage and outputting the driving voltage via an output terminal thereof.

6. The light source unit of claim 5, wherein the light source driver further comprises at least one reverse current blocking diode arranged between the fuse and the direct-current-to-direct-current converter to block an introduction of a reverse current via the input terminal of the driving integrated circuit.

7. The light source unit of claim 5, wherein the light source comprises light emitting blocks including input terminals commonly connected to the output terminal of the direct-current-to-direct-current converter to receive the driving voltage.

8. The light source unit of claim 7, further comprising a connector which electrically connects the output terminal of the direct-current-to-direct converter to the input terminals of the light emitting blocks and electrically connects the driving integrated circuit to output terminals of the light emitting blocks.

9. The light source unit of claim 5, wherein the driving integrated circuit receives a current feedback from the light emitting blocks via the connector and compares the feedback current with a reference level to adjust a level of the driving voltage.

10. A display apparatus comprising:
a display panel which displays an image;
a light source which supplies light to the display panel; and
a light source driver which drives the light source,
wherein the light source driver comprises:
a driving integrated circuit comprising an input terminal which receives an input voltage from an external source, the driving integrated circuit converting the input voltage into a driving voltage which drives the light source, and
a resistance device connected between the input terminal and a ground terminal, the resistance device having a resistance value changed according to a level of the input voltage.

11. The display apparatus of claim 10, wherein the light source driver further comprises a fuse which receives the input voltage from the external source and supplies the input voltage to the input terminal of the driving integrated circuit, and
the fuse is opened when the level of the input voltage is greater than a preset level.

12. The display apparatus of claim 11, wherein the resistance device comprises a varistor, and
the resistance device provides the input voltage to the ground terminal when the fuse opens by decreasing the resistance value when the level of the input voltage is greater than the preset level.

13. The display apparatus of claim 11, wherein the light source driver further comprises at least one capacitor connected in parallel with the resistance device to stabilize the level of the input voltage.

14. The display apparatus of claim 11, wherein the light source driver further comprises a direct-current-to-direct-current converter converting the input voltage passing through the fuse into the driving voltage and outputting the driving voltage via an output terminal thereof.

15. The display apparatus of claim 14, wherein the light source driver further comprises at least one reverse current blocking diode arranged between the fuse and the direct-current-to-direct-current converter to block an introduction of a reverse current via the input terminal of the driving integrated circuit.

16. The display apparatus of claim 14, wherein the light source comprises light emitting blocks including input terminals commonly connected to the output terminal of the direct-current-to-direct-current converter to receive the driving voltage.

17. The display apparatus of claim 16, wherein each of the light emitting blocks comprises light emitting diodes connected in series with each other.

18. The display apparatus of claim 14, further comprising a connector which electrically connects the output terminal of the direct-current-to-direct-current converter to the input terminals of the light emitting blocks and electrically connects the driving integrated circuit to output terminals of the light emitting blocks.

19. The display apparatus of claim 18, wherein the driving integrated circuit receives a current feedback from the light emitting blocks via the connector and compares the feedback current with a reference level to adjust a level of the driving voltage.

20. A method of driving a light source including a light source driver having a driving integrated circuit and a resistance device, the method comprising:
receiving an input voltage from an external source with the driving integrated circuit;
converting the input voltage into a driving voltage and outputting the driving voltage to the light source with the driving integrated circuit; and
supplying the input voltage to a ground terminal by changing a resistance value of the resistance device corresponding to the input voltage when a level of the input voltage exceeds a preset level.
